(19) United States
(12) Patent Application Publication
(10) Pub. No.: US 2026/0043764 A1
(43) Pub. Date: Feb. 12, 2026

(54) REFERENCE ELECTRODES, ELECTROCHEMICAL SYSTEMS, AND METHODS OF MAKING REFERENCE ELECTRODES

(71) Applicant: Battelle Energy Alliance, LLC, Idaho Falls, ID (US)

(72) Inventors: Guy L. Fredrickson, Idaho Falls, ID (US); Tae-Sic Yoo, Idaho Falls, ID (US); David C. Horvath, Idaho Falls, ID (US)

(21) Appl. No.: 19/291,928

(22) Filed: Aug. 6, 2025

Related U.S. Application Data
(60) Provisional application No. 63/679,759, filed on Aug. 6, 2024.

(51) Int. Cl. G01N 27/30; C25C 3/34

(52) U.S. Cl. CPC G01N 27/301; C25C 3/34

(57) ABSTRACT

A reference electrode for use in a molten salt system (e.g., a molten chloride salt medium) includes a housing and a reactive electrode comprising one or more of glassy carbon, graphite, and silver impregnated graphite disposed in the housing. A reference salt comprising silver chloride is in the housing, wherein an amount of the reference salt in the housing is sufficient to at least partially submerge the reactive electrode when the reference salt is in a liquified state. A method of making a reference electrode and an electrochemical system are also disclosed.

### CROSS-REFERENCE TO RELATED APPLICATIONS

This application claims the benefit under 35 U.S.C. § 119(e) of U.S. Provisional Patent Application Ser. No. 63/679,759, filed Aug. 6, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

The disclosure, in various embodiments, relates generally to reference electrodes for use in electrochemical systems. More particularly, this disclosure relates to reference electrodes for use in molten salt systems (e.g., molten halide salt systems) that exhibit improved electrochemical stability and improved physical integrity resulting in increased measurement accuracy and extended service life as compared to conventional (e.g., silver/silver chloride) reference electrodes. The disclosure also relates to methods of making the reference electrodes for use in molten salt systems.

### BACKGROUND

Electrochemical systems (e.g., molten salt systems) may be configured such that various electrochemical measurements may be obtained to evaluate the properties of materials (e.g., molten salt) within the system, so as to evaluate and/or effect the operation of the system. For example, and without limitation, evaluated and/or effected properties may include thermodynamic data of the salt systems, estimation of corrosion phenomena, concentration of electroactive species, system control, and/or complex species formation in a given molten salt system.

Molten salts tend to be highly corrosive because of the elevated temperatures (e.g., from about 350 degrees Celsius (° C.) to about 750° C.) at which many molten salt systems operate, and the increased reactivity of the salts at these elevated temperatures. As a result, the design of reference electrodes for use in molten salt systems are influenced by the corrosiveness of the molten salt system in which they are to be employed. Thus, molten salt system reference electrode design and fabrication presents challenges, particularly as to the materials from which the reference electrode is constructed.

Conventional reference electrodes for use in molten salt systems include an electrode at least partially submerged in a reference salt (e.g., electrolyte) of the molten salt system. The electrode and reference salt are enclosed within a housing having a material of construction which permits ionic conductivity between the reference salt in the reference electrode and a working salt of a molten salt system (e.g., an electrorefiner salt system, a molten salt reactor salt system, a thermal storage salt system). The housing may be sealed with the electrode and reference salt therein. Reference electrodes for use in molten chloride salt systems typically employ a silver (Ag) wire electrode at least partially submerged in a reference salt containing a low concentration of silver chloride (AgCl) (e.g., a eutectic mixture of lithium chloride-potassium chloride (LiCl—KCl) with about one percent by weight (1 wt %) AgCl). The concentration of AgCl may range up to 100 wt % AgCl with no LiCl—KCL salt present. In operation, the reference electrode is at least partially submersed in the working salt of a molten salt system.

### BRIEF SUMMARY

A reference electrode for use in a molten salt system is disclosed. The reference electrode includes a housing and a reactive electrode comprising one or more of glassy carbon, graphite, and silver impregnated graphite disposed in the housing. A reference salt comprising silver chloride is in the housing, wherein an amount of the reference salt in the housing is sufficient to at least partially submerge the reactive electrode when the reference salt is in a liquified state.

An electrochemical system is disclosed comprising an electrolyte comprising a molten salt medium in a crucible, a thermocouple, a working electrode, and a reference electrode in the crucible. The reference electrode comprises a housing constructed of one or more of an ionically conductive material and a porous material and a reactive electrode disposed in the housing. The reactive electrode comprises one or more of glassy carbon, graphite, silver impregnated graphite, metal, and porous metal, the metal and porous metal exhibiting a greater electronegative potential than a metal with a relatively greater electronegative potential in the molten salt medium. A reference salt comprising silver chloride is in the housing, wherein an amount of the reference salt in the housing is sufficient to at least partially submerge in the reactive electrode when the reference salt is in a liquified state.

A method of making a reference electrode for use in molten salt systems is disclosed. The method comprises selecting a housing having one or more of an ionically conductive material and a porous material and positioning a reactive electrode comprising one or more of glassy carbon, graphite, and silver impregnated graphite into the housing. A reference salt comprising silver chloride is added into the housing and the housing is optionally sealed.

### BRIEF DESCRIPTION OF THE DRAWINGS

FIG. 1 is a simplified schematic view of a conventional reference electrode for use in molten salt systems.

FIG. 2 is a simplified schematic view of a reference electrode for molten salt systems, in accordance with embodiments of the disclosure.

FIG. 3 is a photograph of components of a conventional reference electrode and a reference electrode in accordance with embodiments of the disclosure.

FIG. 4 is an enlarged photograph of the components of the conventional reference electrode and the reference electrode of FIG. 3 in accordance with embodiments of the disclosure.

FIG. 5 is a photograph of a conventional reference electrode after use in the experiment described in Example 3.

FIG. 6 is a photograph of silver dendrite formations on a conventional silver wire electrode which was operated in an approximately 100 wt % silver chloride reference salt.

FIG. 7 is a photograph of a silver dendrite which had spalled off of a conventional silver wire electrode.

FIG. 8 is a flow chart of a method of making a reference electrode for use in molten salt systems, in accordance with embodiments of the disclosure.

FIG. 9 is a simplified schematic view of a molten chloride salt system in accordance with embodiments of the disclosure.

FIGS. 10A-10C are graphical representations of the results obtained from the experiment described in Example 1 hereinafter, in accordance with embodiments of the disclosure.

FIG. 11 is a graphical representation of the results obtained from the experiment described in Example 2 hereinafter, in accordance with embodiments of the disclosure.

FIG. 12 is a graphical representation of the results obtained from the experiment described in Example 3 hereinafter, in accordance with embodiments of the disclosure.

FIG. 13 is a graphical representation of the results obtained from the experiment described in Example 4 hereinafter, in accordance with embodiments of the disclosure.

FIG. 14 is a graphical representation of the additional results obtained from the experiment described in Example 4 hereinafter, in accordance with embodiments of the disclosure.

### DETAILED DESCRIPTION

The illustrations presented herein are not actual views of any reference electrode for use in molten salt systems, or any component thereof, but are merely idealized representations, which are employed to describe embodiments of the invention.

As used herein, the singular forms following “a,” “an,” and “the” are intended to include the plural forms as well, unless the context clearly indicates otherwise.

As used herein, “and/or” includes any and all combinations of one or more of the associated listed items.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

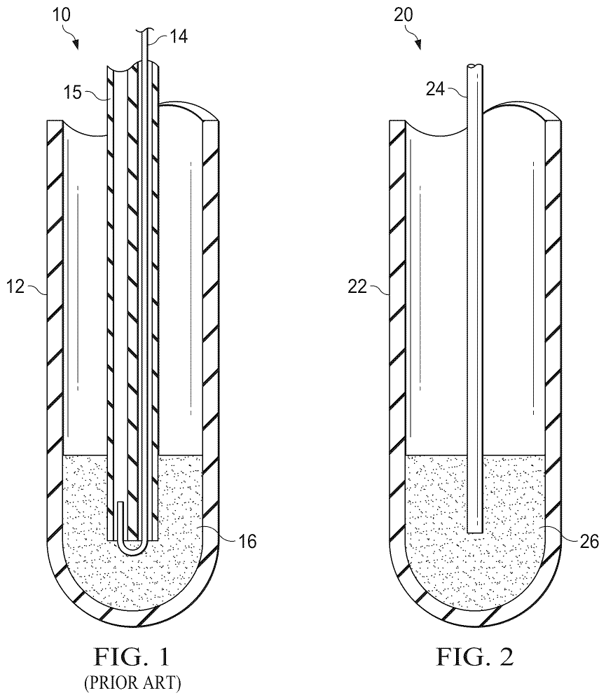

FIG. 1 is illustrative of a conventional reference electrode 10 for use in a molten salt system, and more particularly, a conventional reference electrode 10 (e.g., an Ag/AgCl reference electrode) for use in a molten chloride salt system. A housing 12 is dimensioned and configured to receive a silver wire electrode 14 and an amount of a reference salt 16 (e.g., electrolyte) therein. The silver wire electrode 14 is formed of silver wire and a sheath 15 may be provided to support the silver wire electrode 14 (e.g., a silver wire electrode). The sheath 15 may be include a double bored alumina tube with the silver wire electrode 14 looped therethrough. The silver wire electrode 14 may have a diameter of about 1 millimeter (mm) (e.g., from about 0.5 mm to about 5 mm). The housing 12 is formed of a material (e.g., mullite, alumina, tempered borosilicate glass, such as PYREX® glass, high-silica, high-temperature glass, such as VYCOR® glass) which permits ionic conductivity between the reference salt 16 of the conventional reference electrode 10 and a working salt of a molten salt system external to the conventional reference electrode 10.

The thermodynamic half-cell reaction described by a conventional reference electrode 10 for use in a molten chloride salt system (e.g., a conventional reference electrode 10 having a silver wire electrode 14 in a reference salt 16 formed of a eutectic mixture of LiCl—KCl with about 1 wt % AgCl) is as follows:

Ag(s)+½Cl₂(g)=AgCl(l)=Ag⁺+Cl⁻

Ag(s)=Ag⁺+e⁻(the silver is oxidized)

½Cl₂(g)+e⁻Cl⁻(the chlorine is reduced)

Conventional reference electrodes 10 (e.g., an Ag/AgCl electrode) for use in molten chloride salt systems include true thermodynamic reference electrodes which may be utilized to precisely define the thermodynamic half-cell reaction in a molten salt system, such as the half-cell reaction shown above, when a silver wire electrode is positioned in a reference salt of substantially about 100 percent AgCl. This is due to the fact that the activity coefficient of the 100 percent AgCl reference salt will be 1.0. This is as opposed to pseudo-reference electrodes which cannot precisely define the thermodynamic half-cell reaction in a molten salt system due to low (e.g., unquantifiable) concentrations of ions displaced from the surface of the pseudo-reference electrode and into the surrounding reference salt. More particularly, in a reference salt having less than 100 percent AgCl, the precise concentration of AgCl in the reference salt must be known to calculate the activity coefficient in order to precisely define the thermodynamic half-cell reaction. Thus, a measured potential between a pseudo-reference electrode and a working electrode may vary considerably from an actual potential between a true thermodynamic reference electrode and the working electrode in the same molten salt system.

While the performance (e.g., electrochemical measurements) of conventional reference electrodes 10 for use in molten chloride salt systems are generally acceptable, the measurements obtained are highly susceptible to the concentration of AgCl in the reference salt, particularly at lower concentrations (e.g., about 1 wt % AgCl). The relatively small amount of reference salt in a reference electrode combined with the low concentration of AgCl in the reference salt presents challenges to preparing a reference salt having precisely 1 wt % AgCl in a bulk reference salt (e.g., a mixture of LiCl—KCl, a eutectic mixture of LiCl—KCl). Other salts, such as NaCl—KCl, NaCl, KCl, or a combination thereof, may be used as the bulk reference salt. As a result, the variability in measurements obtained from different conventional reference electrodes can be significant. Greater stability in electrical performance was observed for silver wire electrodes in reference salts having elevated concentrations of AgCl (e.g., about 50 wt % AgCl to about 100 wt % AgCl) in a bulk reference salt (e.g., a eutectic mixture of LiCl—KCl). However, the silver wire electrodes exhibit limited service lifetimes in elevated concentrations of AgCl because the silver wire electrodes are not physically stable in elevated concentrations of AgCl due to the effects of so-called “exchange current density” at the interface between the silver wire electrode and the reference salt containing high concentration of AgCl. Specifically, the “exchange current density” causes the surface morphology of the silver wire to change from a smooth surface to a highly dendritic surface, which ultimately causes the silver wire electrode to fail and lose electrical continuity with external measurement instrumentation. Once the silver wire electrode is compromised (e.g., fails), reliable (e.g., accurate) electrochemical measurements can no longer be obtained with the reference electrode.

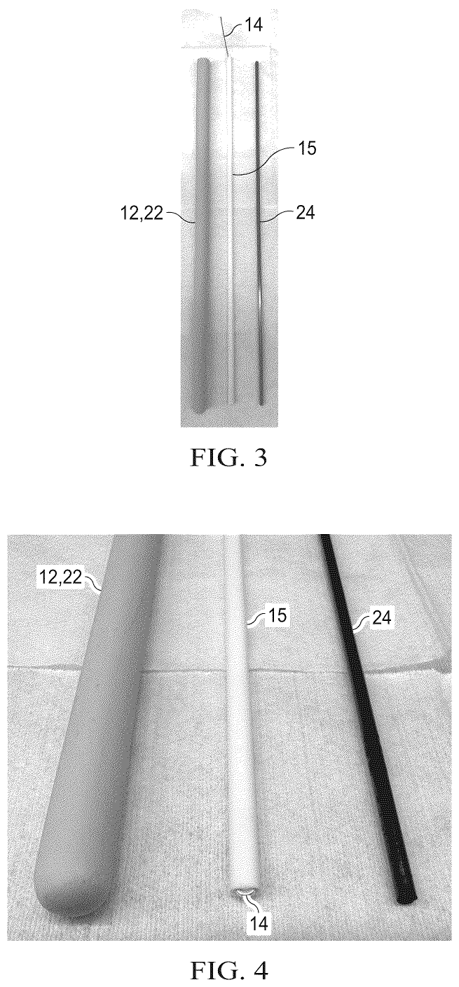

FIG. 2 presents a simplified schematic view of a reference electrode 20 for use in molten salt systems, in accordance with embodiments of the disclosure. As shown in FIG. 2, and similar to the conventional reference electrode 10 of FIG. 1 for use in molten salt systems, the reference electrode 20 includes a housing 22. The housing 22 is dimensioned and configured to receive an electrode 24 (e.g., a reactive electrode, e.g., a glassy carbon electrode) and an amount of a reference salt 26 (e.g., electrolyte) therein. FIGS. 3 and 4 are photographs of components of a conventional reference electrode 10 and a reference electrode 20 in accordance with embodiments of the disclosure. FIGS. 3 and 4 show the housing 12, 22, for housing the silver wire electrode 14 in a sheath 15. FIG. 4 also shows a glassy carbon electrode 24 (e.g., a reactive electrode) in accordance with embodiments of the disclosure. The housing 22 of a reference electrode 20 in accordance with embodiments of the disclosure is formed of and includes a material which permits ionic conductivity between the reference salt 26 contained in the reference electrode 20 and a working salt of a molten salt system (e.g., a molten chloride salt of a molten chloride salt system). The reference salt may be saturated with a metal (e.g., Ag) of the reference electrode (e.g., Ag). The metal may be in the form of particles, such as particles of silver metal. The working salt in the molten salt system may comprise a molten salt media comprising one or more of a chloride-based molten salt media, a fluoride-based molten salt media, and a bromide-based molten salt media. As just one example, the molten chloride salt system may include one or more molten silver chloride (AgCl) salts. Other molten chloride salt systems may include, but are in no manner limited to, molten iron chloride (FeCl₂) salts, molten manganese chloride (MnCl₂) salts, molten chromium chloride (CrCl₂) salts, molten nickel chloride (NiCl₂) salts, or molten molybdenum chloride (MoCl₃) salts. Other molten halide salts may be used, such as a molten fluoride salt of a molten fluoride salt system. In addition, mixed halide salts may be used, such as a molten fluoride salt and a molten chloride salt in a mixed fluoride/chloride salt system. The materials of construction of the housing 22 of the reference electrode 20 may be selected to be chemically compatible with the working salt and the reference salt.

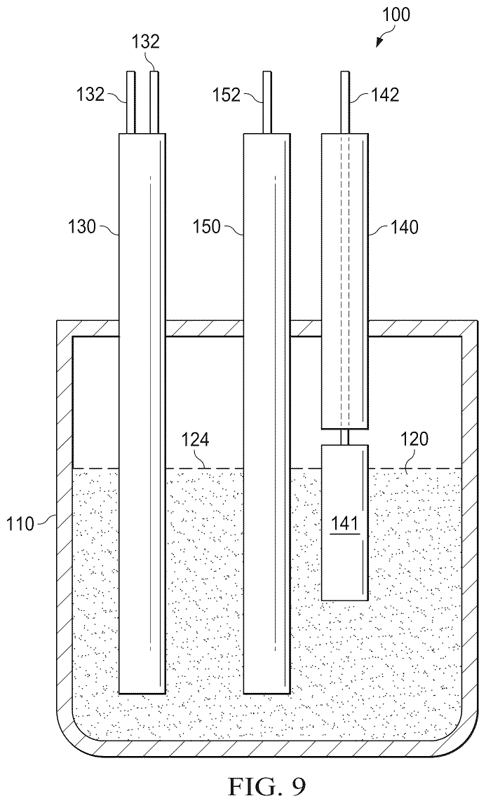

The housing 22 of the reference electrode 20 is formed of an ion-conducting material or a porous material. In accordance with embodiments of the disclosure, the housing of the reference electrode 20 may be formed of materials including, but in no manner limited to, mullite, tempered borosilicate glass, such as PYREX® glass, high-silica, high-temperature glass, such as VYCOR® glass, quartz, porcelain, boron nitride, or alumina. While the ceramic based materials of construction for the housing 22 exhibit greater resistance to the thermal shock which may be experienced in molten salt systems than the glass based materials of construction, portions of a housing 22 made of a ceramic based material may be “thinned” to assure sufficient ionic conductivity between the reference salt 26 contained in the reference electrode 20 and a working salt (e.g., working salt 120 shown in FIG. 9) of a molten salt system (e.g., a molten chloride salt system). The housing 22 may be formed of porous materials including, but in no manner limited to, porous glass (e.g., glass frits), porous ceramic, porous metals, porous cermets, crystalline halide salts, VYCOR® glass, and three-dimensional (3D) printed porous structures. The porous material may be of any pore configuration/porosity (e.g., pore size and pore spacing) provided that the porosity allows for ionic current flow while minimizing the diffusion of the electrode's internal electrolyte into the measured solution. Generally, the smaller the pore diameter the better, with pore diameters being in the micrometer size range, such as from about 0.1 micrometer to about 0.3 micrometer.

With continued reference to FIG. 2, the reference electrode 20 in accordance with embodiments of the disclosure for use in molten salt systems includes an electrode 24 (e.g., a reactive electrode). In at least some embodiments, the electrode 24 is formed of and includes glassy carbon. As demonstrated by the results of the experiment described in Example 3 below, an electrode 24 formed of glassy carbon is substantially equivalent to a silver wire electrode 14 in terms of electrochemical behavior in a reference salt of about one molar percent AgCl in a eutectic mixture of LiCl—KCl. However, unlike a silver wire electrode 14, the electrode 24 formed of and including a material such as glassy carbon does not react with the AgCl, such that formation of silver dendrites in the presence of highly concentrated AgCl (e.g., about 50 wt % AgCl to about 100 wt % AgCl) in a eutectic mixture of LiCl—KCl does not occur on the electrode 24 (e.g., the glassy carbon). Stated otherwise, a reference electrode 20 including an electrode 24 formed of and including glassy carbon may exhibit improved performance (e.g., electrochemical measurements of greater accuracy) as compared to a conventional reference electrode 10. In particular, an electrode 24 formed of and including glassy carbon may be operated in a highly concentrated AgCl reference salt (e.g., from about 50 wt % AgCl to about 100 wt % AgCl) in a eutectic mixture of LiCl—KCl without experiencing the physical degradation resulting from “exchange current density,” such as results in the formation of silver dendrites on conventional silver wire electrodes 14 in highly concentrated AgCl reference salts. Without being bound to any theory, it is believed that electrochemical surface properties of the glassy carbon cause the reference electrode 20 to assume the same potential as a silver wire in a conventional reference electrode 10. The surface morphology of the reference electrode 20 is stable and is not susceptible to changes i.e., the surface morphology of the reference electrode 20 substantially maintains one or more of its original shape, roughness, and texture when used (e.g., operated) in a molten salt system.

In accordance with some embodiments of the disclosure, the electrode 24 (e.g., a reactive electrode) of the reference electrode 20 for use in molten salt systems may be formed of and include glassy carbon, graphite, or silver impregnated graphite. In accordance with other embodiments of the disclosure, an electrode 24 (e.g., a reactive electrode) of a reference electrode 20 may be formed of and include a material (e.g., metal, porous metal) which has a greater electronegative potential than the metal with the most electronegative potential in the molten salt system. In order to be stable with respect to the molten salt medium, a metal or porous metal electrode is selected exhibiting a greater electronegative potential than the metals that are present in the molten salt medium as metal halides. By way of example only, a metal having a greater electronegative potential than the metal in the molten salt system with the most electronegative potential may include tungsten (W) or tantalum (Ta). The electrode 24 in accordance with some embodiments of the disclosure may be a porous metal (e.g., porous tungsten (W), porous tantalum (Ta)). Because molten fluoride salts exhibit a higher solubility for oxide ceramics than molten chloride salts, the housing 22 materials that are compatible in a molten chloride salt system may not be compatible in a molten fluoride salt system. Thus, if the molten salt system is not chemically compatible with an ionic conductive material that may serve as a reference electrode housing, then a non-ionic conductive material may serve as a reference electrode housing provided it is chemically compatible with the molten salt system and porous in the sense that the material provides a physical path for ionic continuity between the reference salt and the working salt.

The reference electrode 20 for use in molten salt systems in accordance with embodiments of the disclosure includes a reference salt 26. The reference salt 26 may include an amount of AgCl. The reference salt 26 may, for example, include an amount of AgCl and one or more of lithium chloride and potassium chloride. More particularly, in some embodiments, the reference salt 26 includes highly concentrated AgCl (e.g., at least about 50 wt % AgCl) in a eutectic mixture of LiCl—KCl, and in at least some other embodiments, the reference salt 26 is substantially about 100 wt % AgCl. Silver metal particles (e.g., silver wire, silver chips, silver flakes, silver powder) may be added to the reference salt 26 in accordance with some embodiments to ensure the reference salt 26 is saturated with silver. The reference electrode 20 may be used at temperatures above the melting point of AgCl (e.g., above 455° C.) or below the melting point of AgCl. The reference electrode may be used at temperatures below the melting point of AgCl even in embodiments where the reference salt comprising substantially about 100 wt % AgCl.

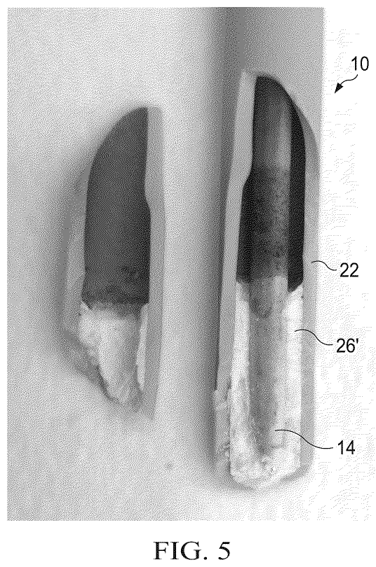

FIG. 5 is a photograph of the conventional reference electrode 10 after use in a molten chloride salt system 100 (FIG. 9) utilized in the experiment described in Example 3 below, wherein the housing 22 was opened to expose the silver wire electrode 14 and dried reference salt 26′ therein.

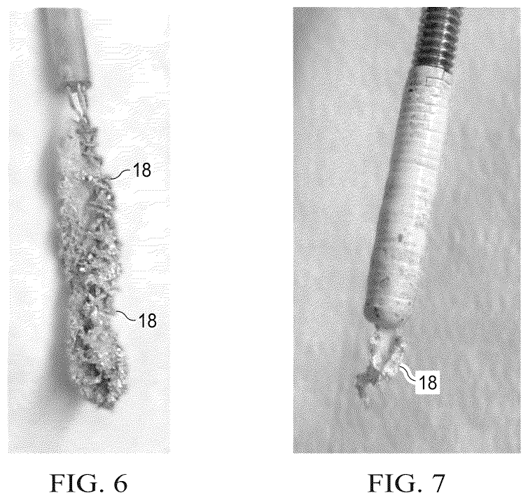

FIG. 6 is a photograph illustrative of silver dendrites 18 on a conventional silver wire electrode after operating in a reference salt having elevated concentrations of AgCl (e.g., 100 wt % AgCl). FIG. 7 is a photograph of a silver dendrite 18 which spalled off of a conventional silver wire electrode (e.g., the silver wire electrode of FIG. 6) and into the working salt of an experimental molten salt system. The silver dendrite 18 in FIG. 7 was retrieved with a salt sample obtained on a threaded rod inserted into the working salt of the experimental molten salt system. Silver dendrites which spall off of a conventional silver wire electrode and into a reference salt containing AgCl can increase the concentration of silver in the reference salt, resulting in further inaccuracies in the electrochemical measurements obtained with a conventional Ag/AgCl reference electrode. In contrast to the conventional electrode, the electrode 24 (i.e., the glassy carbon electrode) in accordance with the present embodiments shows no signs of degradation, dendrite formation or spalling thereof, such as is visible on the conventional silver wire electrode shown in FIG. 6.

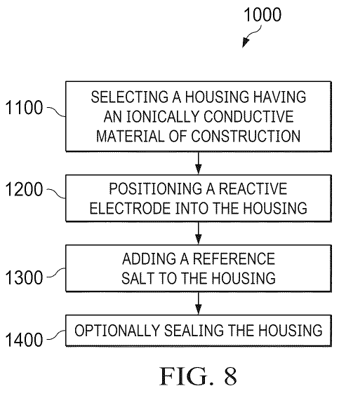

FIG. 8 is a block diagram of a method 1000 of making a reference electrode for use in molten salt systems, in accordance with embodiments of the disclosure. As shown in FIG. 8, the method 1000 of making a reference electrode for use in molten salt systems includes an act of selecting 1100 a material of a housing having an ionically conductive material of construction. As previously described, the housing may be constructed of, but is in no manner limited to, mullite, tempered borosilicate glass, such as PYREX® glass, high-silica, high-temperature glass, such as VYCOR® glass, quartz, porcelain, boron nitride, or alumina. The method 1000 also includes an act of positioning 1200 an electrode (e.g., a reactive electrode) into the housing. An electrode (e.g., a reactive electrode) in accordance with some embodiments of the disclosure may be formed of and include glassy carbon. In accordance with other embodiments, an electrode (e.g., a reactive electrode) may be formed of and include graphite, silver impregnated graphite, metal, or a porous metal (e.g., W, Ta).

With continued reference to FIG. 8, the method 1000 of making a reference electrode for use in molten salt systems also includes an act of adding 1300 a reference salt (e.g., electrolyte) to the housing. The act of adding 1300 a reference salt to the housing includes adding a sufficient amount of the reference salt to at least partially submerge the electrode (e.g., a reactive electrode) in the reference salt, while the reference salt is in a liquified state. In accordance with some embodiments of the disclosure, the reference salt is a highly concentrated AgCl reference salt, such as containing from about 50 wt % AgCl to about 100 wt % AgCl, or about 75 wt % AgCl, or about 85 wt % AgCl, or about 95 wt % AgCl, or substantially about 100 wt % AgCl. The act of adding 1300 the reference salt to the housing may include adding 1300 the reference salt to the housing while the reference salt is in a liquified state. In accordance with at least some embodiments, the act of adding 1300 the reference salt to the housing includes adding the reference salt to the housing while the reference salt is in a solid state (e.g., solid beads, solid powder).

The method 1000 of making a reference electrode for use in molten salt systems may also include an act of sealing 1400 the housing. Sealing may be by any method as known in the art. For example, sealing may comprise employing a temperature-compatible sealant such as a polytetrafluoroethylene (PTFE) stopper, a rubber grommet, non-hardening PTFE tape, high-temperature epoxy, or ceramic sealant. In some applications, the reference electrode will be exposed to extremely high radiation (beta, alpha, gamma, and neutron) requiring sealants that can withstand the high radiation. More particularly, the method 1000 may include the act of sealing 1400 the housing after the electrode has been positioned into the housing and the reference salt has been added to the housing, such that the electrode and the reference salt are retained in the housing during operation of the reference electrode in a molten salt system (e.g., an electrorefiner salt system, a molten salt reactor salt system, a molten salt thermal storage salt system). A pressure release vent may be provided to relieve pressure from inside the reference electrode as the reference electrode is brought to operating temperature, thus preventing pressure build up inside. By reducing the pressure buildup, damage to the reference electrode housing may be reduced or substantially eliminated.

A reference electrode in accordance with embodiments of the disclosure (e.g., reference electrode 20) includes an electrode (e.g., reactive electrode 24) which is at least partially submersed in a reference salt (e.g., reference salt 26) within a housing (e.g., housing 22) of the reference electrode. In use, a portion of the reference electrode (e.g., the housing 22 of the reference electrode 20) is at least partially submersed into an amount of molten salt of a molten salt system (e.g., a molten silver chloride (AgCl) salt system; a molten iron chloride (FeCl₂) salt system; a molten manganese chloride (MnCl₂) salt system; a molten chromium chloride (CrCl₂) salt system; a molten nickel chloride (NiCl₂) salt system; a molten molybdenum chloride (MoCl₃) salt system). A working electrode (e.g., working electrode 140, described below) and a thermocouple (e.g., thermocouple 130, described below) are also at least partially submersed in the molten salt system. The reference electrode, the working electrode and the thermocouple are connected to a measurement and recording device. During operation of the molten salt system, various electrochemical measurements may be obtained by the reference electrode, in conjunction with the working electrode and the thermocouple, to evaluate the properties of the molten salt system, so as to evaluate and/or effect the operation of the system. For example, and without limitation, evaluated and/or effected properties may include thermodynamic data of the molten salt system, estimation of corrosion phenomena, concentration of electroactive species, system control, and/or complex species formation in a given molten salt system.

The reference electrode according to embodiments of the disclosure exhibits improved electrochemical stability and improved physical integrity resulting in increased measurement accuracy and extended service life as compared to conventional (e.g., silver/silver chloride) reference electrodes. The reference electrode may, for example, be used in a highly concentrated AgCl reference salt (e.g., from about 50 wt % AgCl to about 100 wt % AgCl) for a longer amount of time than a silver/silver chloride reference electrode. The reference electrode according to embodiments of the disclosure may also be insensitive to a concentration of the reference salt used.

The following examples serve to explain embodiments of the disclosure in more detail. These examples are not to be construed as being exhaustive or exclusive as to the scope of this disclosure.

### EXAMPLES

FIG. 9 is a simplified schematic view of an experimental molten chloride salt system 100 utilized to conduct the experiments described in Examples 1-4, in accordance with embodiments of the disclosure. The experimental molten chloride salt system 100 included a crucible 110 which contained an amount of molten salt 120 (e.g., working salt) therein. The working salt 120 included a eutectic mixture of LiCl—KCl, AgCl, and combinations thereof, ranging from about 100 molar percent (mol %) LiCl—KCl to about 100 mol % AgCl. Dashed line 124 is illustrative of the level of the working salt 120 contained in the crucible 110 while the experiments described in Examples 1-4 below were conducted.

With continued reference to FIG. 9, the molten chloride salt system 100 included a thermocouple 130 which was partially submersed in the working salt 120 in the crucible 110. The thermocouple 130 had thermocouple leads 132 connected to a measurement and recording device (not shown). A working electrode 140 included a silver rod 141 which was also partially submersed in the working salt 120. The working electrode 140 had a working electrode lead 142 also connected to the measurement and recording device. Lastly, the experimental molten chloride salt system 100 included a reference electrode 150 which included either a conventional silver wire electrode 14 (a control reference electrode), as described hereinabove, or an electrode 24 (e.g., reactive electrode) according to embodiments of the disclosure and formed of glassy carbon, also as described hereinabove. The reference electrode 150 was partially submersed in the working salt 120 (e.g., molten salt) and included a reference electrode lead 152 connected to the measurement and recording device.

Examples 1-4 below describe the experiments conducted with the experimental molten chloride salt system 100 of FIG. 9, and the results obtained from the experiments.

### Example 1

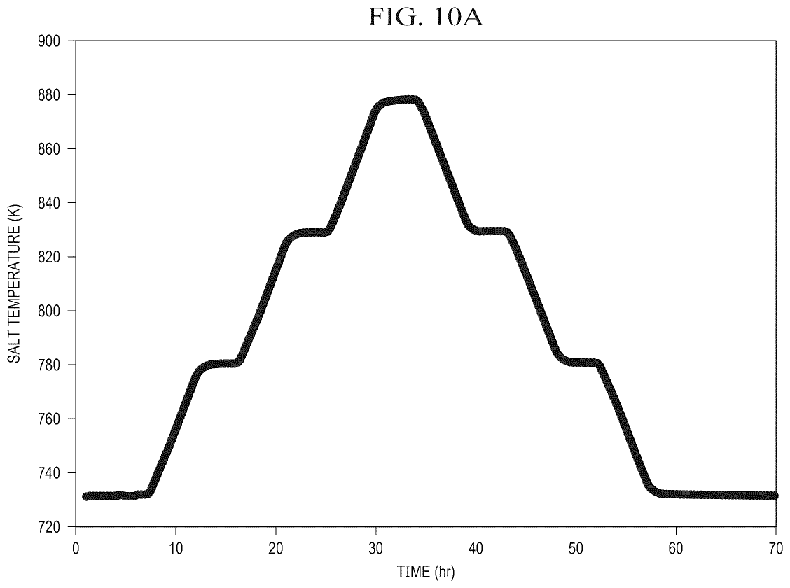

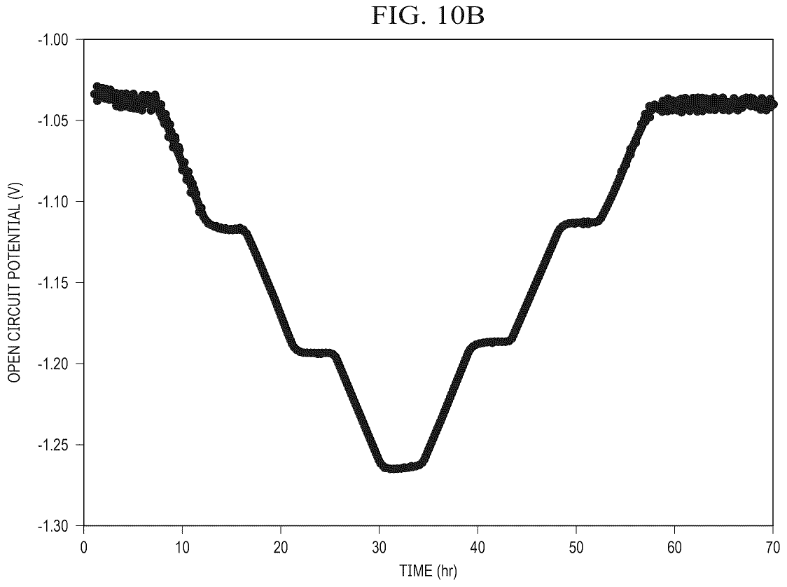

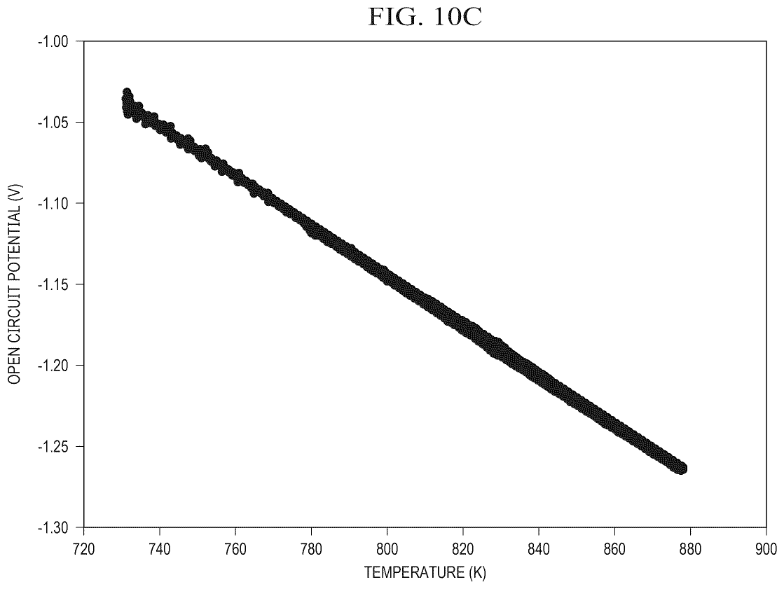

A control experiment utilized a conventional silver wire electrode (electrode 10 shown in FIG. 1) as the reference electrode 150 in the molten chloride salt system 100 of FIG. 9, partially submersed in a working salt 120 which included about 1 molar percent (1 mol %) of AgCl in the eutectic mixture of LiCl—KCl. The thermocouple 130 was utilized to obtain measurements of the temperature of the working salt 120 over a period of time of about 70 hours during which the temperature of the working salt 120 was ramped up stepwise from about 730 Kelvin (K) to about 880 K, after which the temperature of the working salt was ramped down stepwise from about 880 K to about 730 K. As shown in FIG. 10A, the measured temperature values (K) of the working salt 120 were plotted along the Y-axis against time (hours) along the X-axis.

Concurrent with the measurement of the temperature of the working salt 120, the open circuit potential (OCP) between the working electrode 140 and the reference electrode 150 was measured over the 70-hour period during which the temperature of the working salt 120 was ramped up and ramped down again. The measured OCPs values ranged from a high of about −1.03 volts (V) at time zero, to a low of about −1.26 V from about 30 hours to 35 hours while the working salt 120 was at the highest temperature of about 880 K, and then back up to about −1.03 V after 70 hours, when the working salt 120 had cooled back down to about 730 K. As shown in FIG. 10B, the measured OCP values of the working salt 120 were plotted along the Y-axis against time (hours) along the X-axis. As may be seen from the figures, the measured OCP values plotted in FIG. 10B were essentially inversions of the measured temperature values plotted in FIG. 10A.

The measured temperature values (K) plotted in FIG. 10A and the measured OCP values (V) plotted in FIG. 10B were combined to create FIG. 10C, where the measured OCP values (V) were plotted along the Y-axis against the measured temperature values (K) along the X-axis. As shown in FIG. 10C, the relationship between the measured OCP values and the measured temperature values in the working salt 120 was substantially linear.

### Example 2

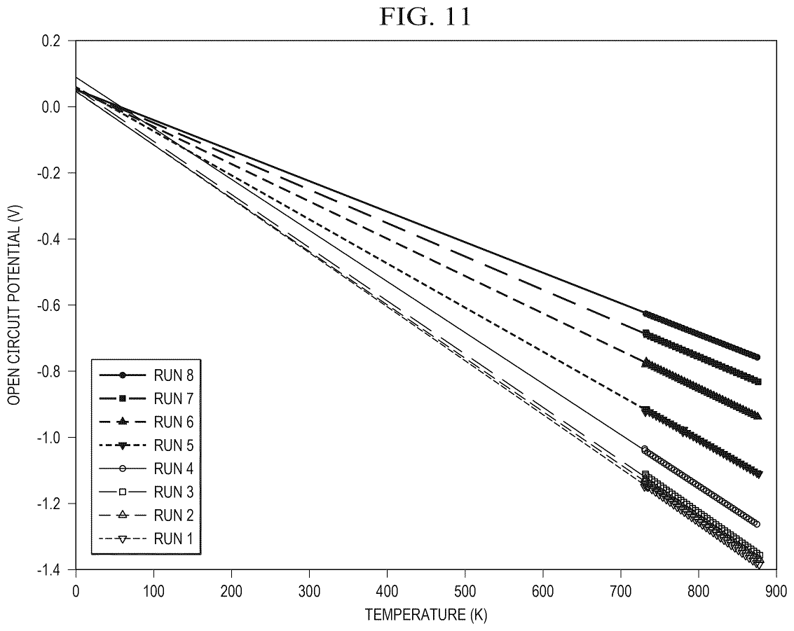

Experimental Runs 1 through 8 were conducted in the same manner as the control experiment conducted in accordance with Example 1, with the exception that the working salt 120 in Experimental Runs 1 through 8 included varied amounts of AgCl in the eutectic mixture of LiCl—KCl. As in Example 1, the temperature and OCP values in the working salt 120 were measured over a 70-hour period of time, and the measured values were plotted against one another, where the measured OCP values (V) were plotted along the Y-axis against the measured temperature values (K) along the X-axis, as shown in FIG. 11.

Specifically, Experimental Runs 1 through 3 were conducted in a working salt 120 which included the eutectic mixture of LiCl—KCl with no added AgCl (i.e., substantially about 100 mol % of the eutectic mixture of LiCl—KCl). The results obtained from Experimental Runs 1 through 3 are plotted in FIG. 11 and the results were consistent with one another and demonstrated the lowest OCP values measured in the experimental runs. Experimental Run 4 was conducted in a working salt 120 which included about 0.001 mol % AgCl in the eutectic mixture of LiCl—KCl. The results obtained from Experimental Run 4 are also plotted in FIG. 11 and the results obtained demonstrated the next lowest OCP values measured, such that the results plotted for Experimental Run 4 appeared just above the results plotted for Experimental Runs 1 through 3.

Experimental Runs 5 through 8 were conducted in a similar manner, with a greater amount of AgCl included in the working salt 120 in each. Specifically, Experimental Run 5 was conducted in a working salt 120 which included about 0.01 mol % AgCl in the eutectic mixture of LiCl—KCl; Experimental Run 6 was conducted in a working salt 120 which included about 0.1 mol % AgCl in the eutectic mixture of LiCl—KCl; Experimental Run 7 was conducted in a working salt 120 which included about 0.387 mol % AgCl, which is equivalent to about 1 wt % AgCl, in the eutectic mixture of LiCl—KCl; and, Experimental Run 8 was conducted in a working salt 120 which included about 1 mol % AgCl in the eutectic mixture of LiCl—KCl.

The results obtained from experimental Runs 5 through 8 are also plotted in FIG. 11, and the results obtained demonstrated that the measured OCP values increased as the concentration of AgCl in the working salt 120 increased.

A conventional silver wire electrode (electrode 10 shown in FIG. 1) was utilized as the reference electrode 150 in each of Experimental Runs 1 through 8. As may be seen from FIG. 11, the results obtained with the conventional silver wire electrode utilized as the reference electrode 150 in the measurement of the OCP values were highly dependent on the concentration of AgCl in the working salt 120 at low concentrations (e.g., AgCl concentration of about 1 mol % or less).

### Example 3

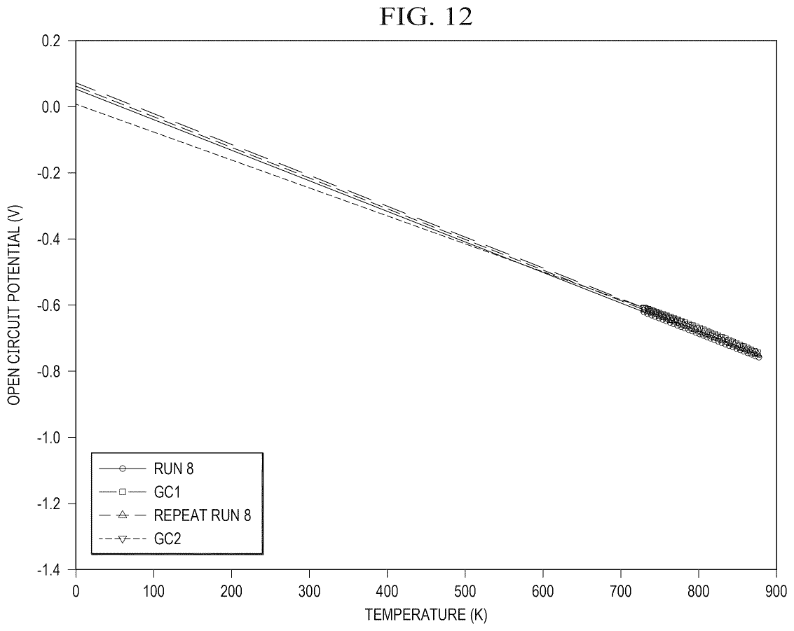

The results obtained from the experimental runs of Example 3 are presented in FIG. 12. As may be seen from FIG. 12, the results obtained from Experimental Run 8 of Example 2, which utilized a conventional silver wire electrode (electrode 10 shown in FIG. 1) as the reference electrode 150, were reproduced in FIG. 12 as the first Experimental Run (i.e., Run 8). The second Experimental Run in accordance with Example 3 utilized the composition of the working salt 120 of Experimental Run 8, namely, a working salt 120 which included about 1 mol % AgCl in the eutectic mixture of LiCl—KCl. However, the second Experimental Run in accordance with Example 3 utilized a glassy carbon (GC) rod as the reference electrode 150 (electrode 20 shown in FIG. 2), and the results obtained from the second Experimental Run in accordance with Example 3 were also plotted in FIG. 12 (i.e., GC1). Third and fourth Experimental Runs were conducted in accordance with Example 3 which replicated Experimental Run 8 of Example 2, which utilized a conventional silver wire electrode (electrode 10 shown in FIG. 1) as the reference electrode 150, and which replicated the second Experimental Run of Example 3, which utilized the glassy carbon rod electrode (electrode 20 shown in FIG. 2) as the reference electrode 150, respectively. The results of the third and fourth Experimental Runs of Example 3 are also plotted in FIG. 12 (i.e., Repeat Run 8 and GC2, respectively).

As may be seen from FIG. 12, the results obtained from Experimental Run 8 of Example 2, which was replicated in Example 3; and, the results obtained from the second Experimental Run of Example 3, and the results obtained from the fourth Experimental Run in accordance with Example 3, which replicated the second Experimental Run, both of which utilized the glassy carbon rod (electrode 20 shown in FIG. 2) as the reference electrode 150, were highly consistent with one another. More particularly, the OCP values measured with the glassy carbon electrode (electrode 20 shown in FIG. 2) were substantially the same as the OCP values measured with the conventional silver wire electrode (electrode 10 shown in FIG. 1), which indicated that the glassy carbon electrode could be substituted for the conventional silver wire electrode in a reference electrode for use in molten salt systems, without adversely affecting the accuracy of the OCP values measured.

### Example 4

The experimental runs conducted in accordance with Example 4, namely, odd numbered Experimental Runs 9 through 21, which were replicated in even numbered Experimental Runs 10 through 22, were conducted in a similar manner to Experimental Runs 1-8 of Example 2 utilizing a conventional silver wire electrode (electrode 10 shown in FIG. 1) as the reference electrode 150, with elevated concentrations of AgCl (e.g., AgCl concentrations of about 50 mol % or greater) in the working salt 120.

Specifically, Experimental Runs 9 and 10 were conducted in a working salt 120 which included AgCl with no eutectic mixture of LiCl—KCl added (i.e., substantially about 100 mol % AgCl); Experimental Runs 11 and 12 were conducted in a working salt 120 which included about 95 mol % AgCl in the eutectic mixture of LiCl—KCl; Experimental Runs 13 and 14 were conducted in a working salt 120 which included about 90 mol % AgCl in the eutectic mixture of LiCl—KCl; Experimental Runs 15 and 16 were conducted in a working salt 120 which included about 80 mol % AgCl in the eutectic mixture of LiCl—KCl; Experimental Runs 17 and 18 were conducted in a working salt 120 which included about 70 mol % AgCl in the eutectic mixture of LiCl—KCl; Experimental Runs 19 and 20 were conducted in a working salt 120 which included about 60 mol % AgCl in the eutectic mixture of LiCl—KCl; and, Experimental Runs 21 and 22 were conducted in a working salt 120 which included about 50 mol % AgCl in the eutectic mixture of LiCl—KCl.

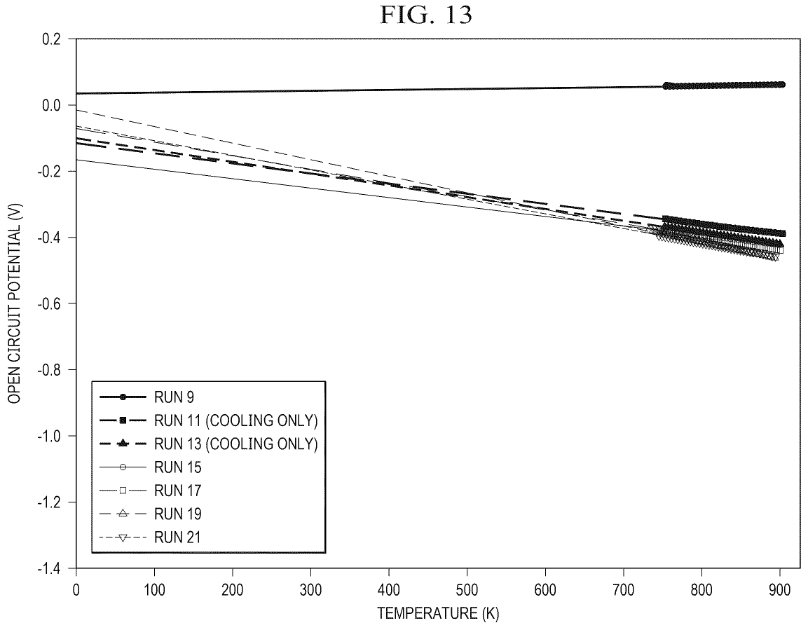

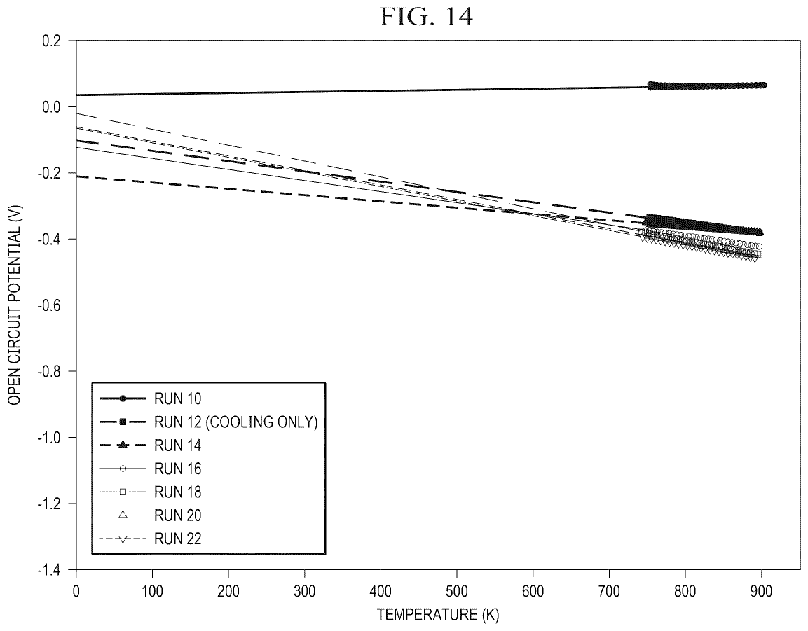

A conventional silver wire electrode (electrode 10 shown in FIG. 1) was utilized as the reference electrode 150 in each of Experimental Runs 9 through 22. The results obtained from odd numbered Experimental Runs 9 through 21 were plotted in FIG. 13 and the results obtained from even numbered Experimental Runs 10 through 22 were plotted in FIG. 14. As seen in FIGS. 13 and 14, with the exception of the results obtained in AgCl with no eutectic mixture of LiCl—KCl added (i.e., substantially about 100 mol % AgCl) in Experimental Runs 9 and 10, the results obtained demonstrated that at elevated concentrations of AgCl in the working salt (e.g., about 50 wt % AgCl or greater in the eutectic mixture of LiCl—KCl), the measured OCP values were not appreciably dependent on the concentration of AgCl in the working salt 120. As further shown in FIGS. 13 and 14, the measured OCP values obtained in AgCl with no eutectic mixture of LiCl—KCl added (i.e., substantially about 100 mol % AgCl) in Experimental Runs 9 and 10 were not appreciably dependent on the temperature of the working salt 120.

The results from the experiments conducted in accordance with Examples 1-4 demonstrated that a reference electrode 20 (e.g., a reactive electrode, such as, electrode 24 constructed of glassy carbon as in FIGS. 2 and 5) in a reference salt (e.g., the reference salt 26 of FIG. 2) of substantially about 100 mol % AgCl may be utilized. The results further demonstrated that a reference electrode having an electrode constructed of glassy carbon (e.g., a reactive electrode 24) in a reference salt of substantially about 100 mol % AgCl approaches the behavior of a true thermodynamic reference electrode as the electrochemical measurements obtained with the reference electrode were not appreciably dependent on the concentration of AgCl in the reference salt at elevated concentrations (e.g., AgCl concentrations of about 50 mol % or greater). Stated otherwise, the results demonstrated that the electrical potentials measured with a reference electrode having an electrode constructed of glassy carbon (e.g., a reactive electrode) were less sensitive to AgCl concentration at higher AgCl concentrations (e.g., FIGS. 13 and 14) than at lower AgCl concentrations (e.g., FIGS. 11 and 12), although a potential shift was observed from an AgCl concentration of about 100 mol % to the next highest AgCl concentration (e.g., about 95 mol % AgCl).

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. A reference electrode for use in a molten salt system comprising:
a housing;
a reactive electrode comprising one or more of glassy carbon, graphite, and silver impregnated graphite disposed in the housing; and
a reference salt comprising silver chloride in the housing, wherein an amount of the reference salt in the housing is sufficient to at least partially submerge the reactive electrode when the reference salt is in a liquified state.

2. The reference electrode of claim 1, wherein the housing comprises one or more of an ionically conductive material and a porous material.

3. The reference electrode of claim 1, wherein the housing comprises mullite, tempered borosilicate glass, high-silica, high-temperature glass, quartz, porcelain, boron nitride, or alumina.

4. The reference electrode of claim 1, wherein the housing comprises mullite.

5. The reference electrode of claim 1, wherein the housing comprises porous glass, glass frit, porous ceramic, porous metal, porous cermet, crystalline halide salt, or a 3D printed porous structure.

6. The reference electrode of claim 1, wherein the reactive electrode comprises glassy carbon.

7. The reference electrode of claim 1, wherein the reference salt comprises at least about 50 weight percent silver chloride.

8. The reference electrode of claim 1, wherein the reference salt comprises substantially about 100 weight percent silver chloride.

9. The reference electrode of claim 8, wherein the reference salt further comprises silver metal therein.

10. The reference electrode of claim 1, wherein the reference salt further comprises one or more of lithium chloride and potassium chloride.

11. The reference electrode of claim 1, wherein the reference salt further comprises a eutectic mixture of lithium chloride-potassium chloride.

12. An electrochemical system, comprising:
an electrolyte comprising a molten salt medium in a crucible;
a thermocouple and a working electrode in the crucible; and
a reference electrode in the crucible, the reference electrode comprising:
a housing comprising one or more of an ionically conductive material and a porous material;
a reactive electrode comprising glassy carbon, graphite, silver impregnated graphite, metal, or porous metal, the metal or porous metal exhibiting a greater electronegative potential than a metal with a relatively greater electronegative potential in the molten salt medium disposed in the housing; and
a reference salt comprising silver chloride in the housing, wherein an amount of the reference salt in the housing is sufficient to at least partially submerge the reactive electrode when the reference salt is in a liquified state.

13. The electrochemical system of claim 12, wherein the molten salt medium comprises one or more of a chloride-based molten salt medium, a fluoride-based molten salt medium, and a bromide-based molten salt medium.

14. The electrochemical system of claim 12, wherein the reactive electrode comprises glassy carbon.

15. The electrochemical system of claim 12, wherein the reference salt comprises from at least about 50 weight percent silver chloride to substantially about 100 weight percent silver chloride.

16. The electrochemical system of claim 12, wherein the reference salt further comprises silver metal therein.

17. The electrochemical system of claim 12, wherein the reference salt further comprises a eutectic mixture of lithium chloride-potassium chloride.

18. The electrochemical system of claim 12, wherein the reference electrode exhibits a stable surface morphology.

19. The electrochemical system of claim 12, wherein the electrochemical system is configured as an electrorefiner system, a molten salt reactor salt system, or a molten salt thermal storage system.

20. A method of making a reference electrode for use in a molten salt system comprising:
selecting a housing material comprising one or more of an ionically conductive material and a porous material;
positioning a reactive electrode comprising one or more of glassy carbon, graphite, and silver impregnated graphite into the housing material; and
adding a reference salt comprising silver chloride into the housing material.

21. The method of claim 20, wherein:
positioning a reactive electrode into the housing material comprises positioning a reactive electrode comprising glassy carbon; and
wherein adding a reference salt comprising silver chloride into the housing material comprises adding a reference salt comprising from at least about 50 weight percent silver chloride to substantially about 100 weight percent silver chloride.

22. The method of claim 20, further comprising sealing the housing material.
